(19) United States
(12) Patent Application Publication
(10) Pub. No.: US 2007/0021157 A1
(43) Pub. Date: Jan. 25, 2007

(54) Short-distance wireless transmission system for data transmission among electronic devices on a vehicle

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/344,134

(22) Filed: Feb. 1, 2006

(30) Foreign Application Priority Data
Jul. 25, 2005 (TW) 094125097

(51) Int. Cl. H04M 1/00

(52) U.S. Cl. 455/575.3; 455/556.1

(57) ABSTRACT

A short-distance wireless transmission system for data transmission among electronic devices on a motor vehicle is disclosed to have on-vehicle electronic devices defined with a respective identification code and divided into groups with the electronic devices of the same group connected together by a respective bus that is connected to a respective Bluetooth module so that when one electronic device is sending a data through the connected Bluetooth module, the identification code of the destination device is added to the data for enabling the corresponding Bluetooth module to receive the data accurately and to send the data to the destination electronic device through the respective bus.

### BACKGROUND OF THE INVENTION

1. Field of the Invention

The present invention relates to a short-distance wireless transmission system and more particularly, to such a short-distance wireless transmission system that is practical for data transmission among electronic devices on a vehicle.

2. Description of Related Art

A car may carry a variety of supplementary electronic devices, such as a navigation device, a car stereo system, a multimedia video system, a driving assistant system, a mobile communication device, etc. These electronic devices may be installed in the car at locations far away from one another. If data transmission among these electronic devices is necessary, long electric wires must be used to connect these electronic devices. In this case, the installation procedure of these electronic devices will be very complicated.

If the car owner wishes to add other electronic devices to his (her) car and the car has no extra wiring for extra electronic devices, the car owner may have to detach the car's internal seats, carpet, ornamental panels and other accessories so that a new wiring can be arranged inside the car for the new electronic devices to be added to the car. After installation of the new electronic devices, the car's internal seats, carpet, ornamental panels and other accessories must be re-installed. This procedure is complicated and wastes much time and labor. Further, the car's internal parts may become unstable after re-installation, and may produce noises during running of the car.

### SUMMARY OF THE INVENTION

The present invention provides a short-distance wireless transmission system for data transmission among electronic devices on a motor vehicle. The short-distance wireless transmission system comprises a first electronic device group and a second electronic device group. The first electronic device group comprises a first short-distance wireless transmitter, at least one first electronic device, and a first connection line that electrically connects the first short-distance wireless transmitter to the at least one first electronic device. The at least one first electronic device each is defined to have a respective first identification code. The second electronic device group comprises a second short-distance wireless receiver, at least one second electronic device, and a second connection line that electrically connects the second short-distance wireless receiver to the at least one second electronic device. The at least one second electronic device each is defined to have a respective second identification code.

The at least one first electronic device each is adapted to send a first transmission data to the first short-distance wireless transmitter through the first connection line, for enabling the first short-distance wireless transmitter to send out the first transmission data wirelessly. The first transmission data comprises at least one first destination code therein. The second short-distance wireless receiver is adapted to receive the first transmission data wirelessly and then to send the received first transmission data through the second connection line to at least one corresponding second electronic device of which the respective second identification code conformed to the at least one first destination code of the received first transmission data.

Therefore, a connection line can electrically connect adjacent electronic devices to one another, and electronic devices that are at remote locations can communicate with one another through a short-distance wireless transmitter and a short-distance wireless receiver. Therefore, the invention allows the car owner to add or reduce on-vehicle electronic devices conveniently without detaching and reinstallation of vehicle internal parts and accessories. Therefore, the invention allows the motor vehicle to be conveniently set to fit the owner's requirement.

Further, the aforesaid first short-distance wireless transmitter and second short-distance wireless receiver can be Bluetooth modules, 802.11 modules, infrared modules, microwave modules, or other suitable equivalent short-distance wireless communication devices.

Further, the first connection line and the second connection line can be regular electric wires, fiber-optic cables, or any suitable bus lines.

### BRIEF DESCRIPTION OF THE DRAWINGS

FIG. 1 is a system block diagram of a short-distance wireless transmission system according to a first embodiment of the present invention.

FIG. 2 is a system block diagram of a short-distance wireless transmission system according to a second embodiment of the present invention.

FIG. 3 is a perspective view showing a short-distance wireless transmission system installed in a car according to a third embodiment of the present invention.

### DETAILED DESCRIPTION OF THE PREFERRED EMBODIMENT

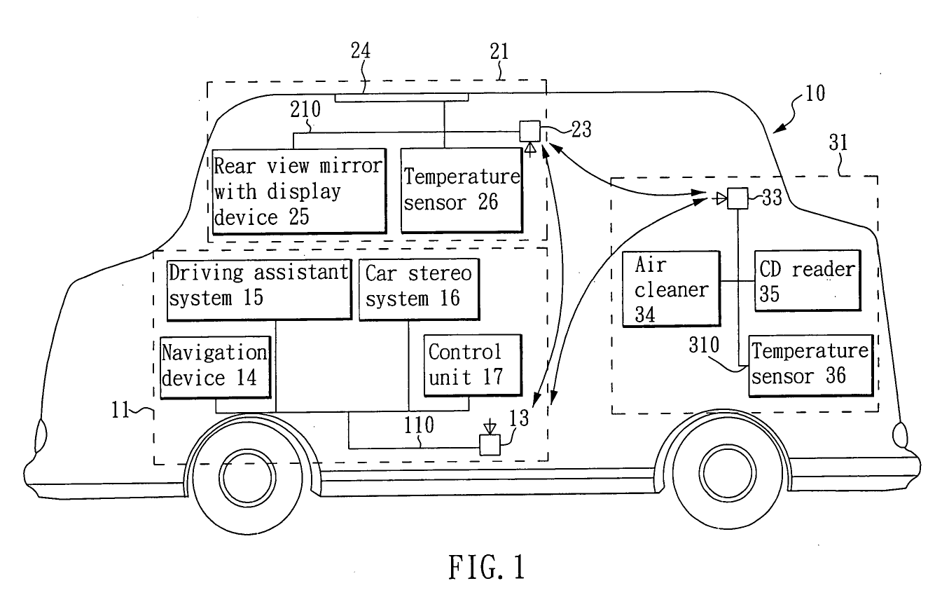

Referring to FIG. 1, a short-distance wireless transmission system is shown installed in a motor vehicle 10 of which the hardness comprises a main control device group 11, a roof device group 21, and a rear device group 31.Namely, in this embodiment separate the electronic devices into three groups by connecting adjacent electronic devices respectively.

Referring to FIG. 1 again, the main control device group 11 comprises a Bluetooth module 13, a navigation device 14, a driving assistant system 15, a car stereo system 16, and a control unit 17. These electronic devices are electrically connected together with a bus 110, for example, a CAN Bus (Controller Area Network Bus).

The roof device group 21 is a group of electronic devices that are installed in the roof of the car. As shown in FIG. 1, the roof device group 21 includes a Bluetooth module 23, a skylight 24, a rearview mirror with display device 25, and a temperature sensor 26. These electronic devices are connected together with a CAN Bus 210.

The rear device group 31 is a group of electronic devices installed in the rear side of the motor vehicle 10. As shown in FIG. 1, the rear device group 31 includes a Bluetooth module 33, an air cleaner 34, a CD reader 35, and a temperature sensor 36. These electronic devices are connected together with a CAN Bus 310.

Every electronic device of every of the aforesaid device groups has a prior defined Identification code for identification recognition during data transmission.

For example, the car air conditioner (not shown) electrically connected to the main control group 11 is automatically controlled to drive the compressor or the electric heater according to the temperature level in the room for passengers. However, the temperature at different locations in the room for passengers is different. Therefore, the control unit 17 must gather the temperature data T1 obtained through the front-sided temperature sensor 26 and the temperature data T2 obtained through the rear-sided temperature sensor 36 and then calculate the mean value. At this time, the temperature sensor 26 of the roof device group 21 will load the detected temperature data T1 and download into a packet and simultaneously add the identification code of the addressee, namely, the control unit 17 to the packet, and then send the packet to the Bluetooth module 23 through the CAN Bus 210, enabling the packet to be sent out into the air by the Bluetooth module 23.

Because the aforesaid packet carries the identification code of the destination—the control unit 17, the other Bluetooth modules 13, 33 will check the identification code contained in the packet at first. However, because the identification code contained in this packet is not in conformity with the corresponding definition of the rear device group 31, the Bluetooth module 33 will refuse this packet. Because the identification code contained in this packet is in conformity with the corresponding definition of the main control device group 11, the Bluetooth module 13 will recognize this identification code and receive this packet and then send this packet to the control unit 17 through the CAN Bus 110.

In the same manner, the temperature sensor 36 of the rear device group 31 will load the detected temperature data T2 into a packet and simultaneously add the identification code of the destination, namely, the main control unit 17 to the packet, and then send the packet to the Bluetooth module 33 through the CAN Bus 310, enabling the packet to be sent out into the air by the Bluetooth module 33. At this time, only the Bluetooth module 13 will receive this packet and then send this packet to the control unit 17 through the CAN Bus 110. Therefore, the control unit 17 can receive both temperature data T1 and T2 and calculate the mean value for reference in controlling the operation of the air conditioner.

Of course, the data transmission among the aforesaid device groups 11, 21 and 31 is not limited to one-way transmission. Because the Bluetooth modules 13, 23 and 23 have transmitter and receiver circuits, the invention allows two-way data transmission along the device groups 11, 21 and 31. Actually, the control unit 17 can send a start or stop command that carries the identification code of the air fresher 34 to the rear device group 31 through the Bluetooth module 13. When this command is received by the Bluetooth module 33, it will be sent to the air fresher 34 through the CAN Bus 310 to start or stop the air cleaner 34. Because this start or stop command contains the identification code of the destination—the air fresher 34, the Bluetooth module 33 can accurately receive the command and accurately send the command to the air fresher 34.

The CD reader 35 of the rear device group 31 can be, for example, a VCD player that may send data to two different devices. For example, the VCD player may send sound source data to the car stereo system 16 of the main control device group 11 for music output, and sound track data to the rearview mirror with display device 25 of the roof device group 21 for displaying the track number of the sound track, name of music tune, lyrics, and/or name of signer of the currently played music. Therefore, when sending a signal, the CD reader 35 may add two or more identification codes to the data, for exampling adding the identification code of the car stereo system 16 and the identification code of the rearview mirror with display device 25 to the data. After receipt of the data by the corresponding Bluetooth modules 13 and 23, the Bluetooth modules 13 and 23 will send the received data to the respective devices, namely, the car stereo system 16 and the rearview mirror with display device 25 respectively for output.

In the same manner, the driver can operate the control unit 17 of the main control device group 11 to send a command to the skylight 24 of the roof device group 21 so as to open the skylight 24, or to send a command to the navigation device 14, causing it to send navigation related data, such as the data of left turn or right turn in the next road entrance, to the rearview mirror with display means 25 for display. The driving assistant system 15 can be controlled in the same manner to show the information of nearby food malls, landscapes, entertainment centers, etc., on the rearview mirror with display device 25.

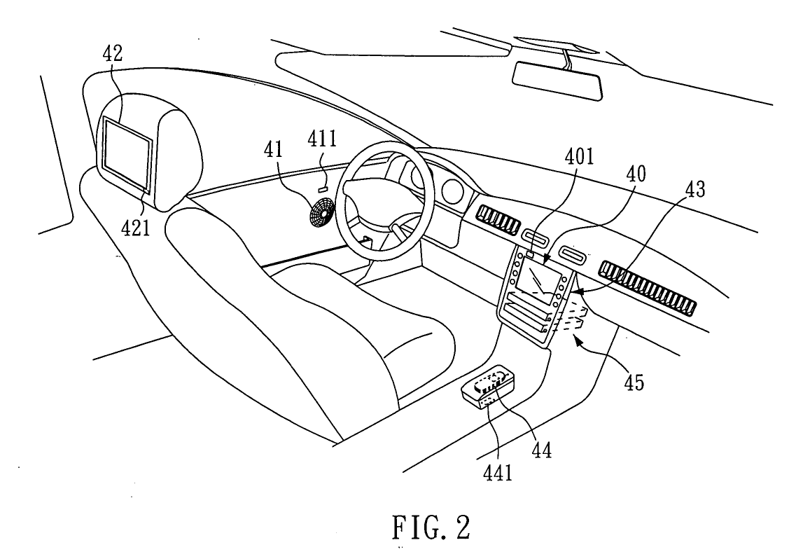

FIG. 2 shows an alternate form of the present invention. According to this embodiment, car speakers 41 are installed in car doors and electrically connected to a Bluetooth module 411, and a CD reader 45 is installed in front of the driver's seat and electrically connected to a Bluetooth module 401. When the car owner wishing to play music, the CD reader 45 reads in music data from the disk at first, and then sends the fetched music data to the Bluetooth module 401 through a lead wire. At this time, the Bluetooth module 401 will send the received music data with the identification code of the destination to the Bluetooth module 411 in the car doors wirelessly. After recognition of the identification code, the Bluetooth module 411 will send the music data to the speakers 41 for output. Therefore, when wishing to change the speakers 41 or the CD reader 45, the car owner needs not to detach the ornamental panels of the car doors or the dashboard or to arrange new electric wires, i.e., the car owner needs only to test the connection of the Bluetooth module 411 or 401 after installation of the new speakers 41 or CD reader 45.

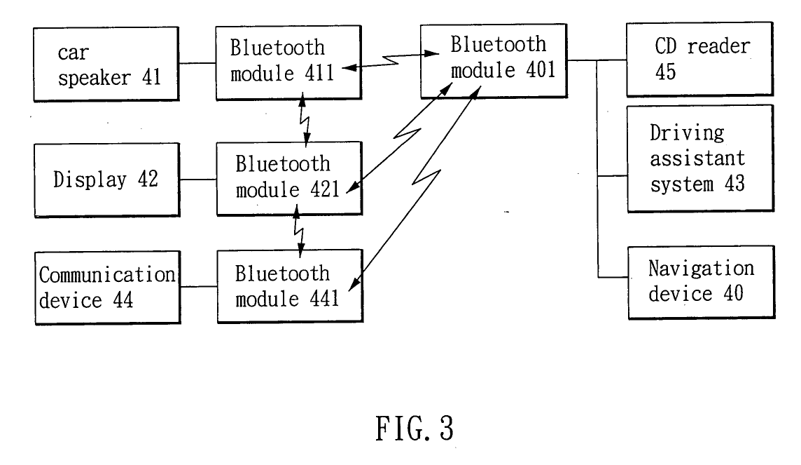

The Bluetooth module 401 shown in FIG. 3 is not only for the connection of the CD reader 45 but also for the connection of the navigation device 40, the driving assistant system 43, etc. to form a big electronic device group. In this electronic device group, every electronic device has the respective identification code for recognition during data transmitting or receiving through the Bluetooth module 401.

Further, data transmission is not limited to the transmission between two electronic device groups. A data may be transmitted from one electronic device group to other two electronic device groups. For example, when the driver connects to the remote driving control center to inquire for travel route, the related serviceman voice data and travel route data will be received by the mobile communication device 44, and then sent by the Bluetooth module 441 to the Bluetooth module 411 and the Bluetooth module 401 for output of voice data through the car speakers 41 and output of image data through the common display of the driving assistant system 43 and the navigation device 40. When playing DVD or VCD data, the CD reader 45 reads in the video and audio data from the DVD or VCD, and then sends the fetched audio and video data through the Bluetooth module 401. The video data contains the identification code of the display 42 that is provided at the back side of the seat. The audio data contains the identification code of the car speakers 41. Therefore, the Bluetooth module 421 and the Bluetooth module 411 can recognized the respective identification code and receive the respective video or audio data for output through the display 42 or the speakers 41 respectively.

As indicated above, by means of the aforesaid short-distance wireless transmission system, the invention eliminates the complicated electric wiring installation work, allows the car driver to add or reduce on-vehicle electronic devices conveniently when desired, without detaching and reinstallation of vehicle internal parts and accessories. Therefore, the motor vehicle 10 can conveniently set to fit the owner's requirement.

Although the present invention has been explained in relation to its preferred embodiments, it is to be understood that many other possible modifications and variations can be made without departing from the spirit and scope of the invention as hereinafter claimed.

What is claimed is:

1. A short-distance wireless transmission system for data transmission among electronic devices on a motor vehicle, comprising:
a first electronic device group, said first electronic device group comprising a first short-distance wireless transmitter, at least one first electronic device, and a first connection line electrically connecting said first short-distance wireless transmitter to said at least one first electronic device, said at least one first electronic device each being defined to have a respective first identification code; and
a second electronic device group, said second electronic device group comprising a second short-distance wireless receiver, at least one second electronic device, and a second connection line electrically connecting said second short-distance wireless receiver to said at least one second electronic device, said at least one second electronic device each being defined to have a respective second identification code;
wherein said at least one first electronic device each is adapted to send a first transmission data to said first short-distance wireless transmitter through said first connection line, for enabling said first short-distance wireless transmitter to send out said first transmission data wirelessly, said first transmission data comprising at least one first destination code therein;
wherein said second short-distance wireless receiver is adapted to receive said first transmission data wirelessly and then to send said received first transmission data through said second connection line to at least one corresponding second electronic device of which the respective second identification code conformed to the at least one first destination code of said received first transmission data.

2. The short-distance wireless transmission system for data transmission among electronic devices on a motor vehicle as claimed in claim 1, wherein said second electronic device group further comprises a second short-distance wireless transmitter electrically connected to said at least one second electronic device through said second connection line; said first electronic device group further comprises a first short-distance wireless receiver electrically connected to said at least one first electronic device through said first connection line;
wherein said at least one second electronic device each is adapted to send a second transmission data to said second short-distance wireless transmitter through said second connection line, for enabling said second short-distance wireless transmitter to send out said second transmission data wirelessly, said second transmission data comprising at least one second destination code therein;
wherein said first short-distance wireless receiver is adapted to receive said second transmission data wirelessly and then to send said received second transmission data through said first connection line to at least one corresponding first electronic device of which the respective first identification code conformed to the at least one second destination code of said received second transmission data.

3. The short-distance wireless transmission system for data transmission among electronic devices on a motor vehicle as claimed in claim 1, further comprising at least one third electronic device group, said at least one third electronic device group each comprising a third short-distance wireless receiver, at least one third electronic device, and a third connection line electrically connecting said third short-distance wireless receiver to said at least one third electronic device, said at least one third electronic device being defined to have a respective third identification code;
Wherein said at least one first electronic device each is adapted to send a third transmission data to said first short-distance wireless transmitter through said first connection line, for enabling said first short-distance wireless transmitter to send out said third transmission data wirelessly, said third transmission data comprising at least one third destination code therein;
Wherein said third short-distance wireless receiver is adapted to receive said third transmission data wirelessly and then to send said received third transmission data through said third connection line to at least one corresponding third electronic device of which the respective third identification code conformed to the at least one third destination code of said received third transmission data.

4. The short-distance wireless transmission system for data transmission among electronic devices on a motor vehicle as claimed in claim 1, further comprising at least one third electronic device group, said at least one third electronic device group each comprising a third short-distance wireless transmitter, at least one third electronic device, and a third connection line electrically connecting said third short-distance wireless transmitter to said at least one third electronic device;
Wherein said at least one third electronic device each is adapted to send a third transmission data to said third short-distance wireless transmitter through said third connection line, for enabling said third short-distance wireless transmitter to send out said third transmission data wirelessly, said third transmission data comprising at least one third destination code therein;
Wherein said second short-distance wireless receiver is adapted to receive said third transmission data wirelessly and then to send said received third transmission data through said second connection line to at least one corresponding second electronic device of which the respective second identification code conformed to the at least one third destination code of said received third transmission data.

5. The short-distance wireless transmission system for data transmission among electronic devices on a motor vehicle as claimed in claim 1, wherein said first short-distance wireless transmitter and said second short-distance wireless receiver are respectively formed of a bluetooth module.

6. The short-distance wireless transmission system for data transmission among electronic devices on a motor vehicle as claimed in claim 1, wherein said first connection line and said second connection line are respectively formed of a Controller Area Network (CAN) Bus.
